(19) United States
(12) Patent Application Publication
(10) Pub. No.: US 2003/0225601 A1
(43) Pub. Date: Dec. 4, 2003

(54) Method of performing risk analysis

(75) Inventors: Jessica Hope Hayden, Danbury, CT (US); James Jeffrey Keirns, Danbury, CT (US); Martha R. Matteo, Pleasantville, NY (US)

Correspondence Address: BOEHRINGER INGELHEIM CORPORATION, 900 RIDGEBURY ROAD, P O BOX 368, RIDGEFIELD, CT, 06877, US

(73) Assignee: Boehringer Ingelheim Pharmaceuticals, Inc., Ridgefield, CT (US)

(21) Appl. No.: 10/159,234

(22) Filed: May 31, 2002

(51) Int. Cl. G06F 17/60

(52) U.S. Cl. 705/7

(57) ABSTRACT

Disclosed are methods for evaluating risk and/or opportunity for research and development programs in the pharmaceutical and biotechnology industries.

### FIELD OF INVENTION

The invention relates to the field of business processes used to systematically analyze risk (and opportunity) for early stage R&D prioritization decisions.

### BACKGROUND OF THE INVENTION

Industries that have considerable research and development (R&D) expenditures require a method to determine the probability of success for individual technical projects. More desirable is a business process used to systematically analyze risk (and opportunity) for early stage R&D prioritization decisions. A common method generally known as ‘multi-attribute utility analysis’ allows users to relatively rank items based on a list of criteria. Each criterion has a relative importance (or weight), and score (anchor points). A summary final score per project can be obtained by doing a mathematical weighted-average calculation of the above. Davis et al., for an example, describes the utilization of such a method. Davis et al., “Determining a Projects Probability of Success”. A report of EIRMA generally describes several R&D evaluation methods but provides no specific criteria for the industries such as biotechnology or pharmaceutical. Evaluation of R&D Projects, EIRMA, Paris, 1995.

The objective problem of R&D evaluation methodology for risk/opportunity specific to industries such as biotechnology or pharmaceutical is solved by the present invention. The special technical feature of incorporating criteria specific to such industries in the process described herein provides a useful method for R&D project and portfolio evaluation.

### SUMMARY OF THE INVENTION

It is therefore an object of the invention to provide a process of evaluating the risk and/or opportunity for multiple R&D projects, said process comprising:

providing a risk and/or opportunity scale from which one or more clients assess said risk and/or opportunity, said scale providing guidance for scoring a range from low to high;

a client providing scores based on their assessment of risk and/or opportunity for a plurality of pharmaceutical or biotechnological criteria;

obtaining risk and/or opportunity data by performing a mathematical weighted-average for each criteria;

optionally obtaining further risk and/or opportunity data by performing a mathematical average for each criteria across projects if more than one project is evaluated;

and further optionally converting said data to a color scale for each measured criteria presented on hard-copy or digital visual medium.

It is another object of the invention to provide an apparatus capable of evaluating the risk and/or opportunity for one or more R&D projects, said apparatus having a computer program operable to process:

providing a risk and/or opportunity scale to a client from which one or more clients interact with said apparatus and assess said risk and/or opportunity, said scale providing guidance for scoring a range from low to high;

a client providing scores based on the scale of risk and/or opportunity for a plurality of pharmaceutical or biotechnological criteria to the apparatus;

the apparatus calculating risk and/or opportunity data by performing a mathematical weighted-average for each criteria;

optionally calculating further risk and/or opportunity data by performing a mathematical average for each criteria across projects if more than one project is evaluated;

and further optionally converting said data to a color scale for each measured criteria; and

the apparatus subsequently presenting on hard-copy or digital visual medium the results to the clients.

Preferred embodiments of the invention are presented below.

### BRIEF DESCRIPTION OF THE DRAWINGS

FIG. 1: depicts a sample questionnaire form presenting a table of criteria, this is used by a client to assess risk for each criteria by placing an ‘X’ for ‘low’, ‘medium’, ‘high’ or ‘N/A’ (not applicable).

FIG. 2: depicts a table representing the scoring data of the sample input form as shown in FIG. 1.

FIG. 3. Depicts the basic steps by which an exchange between an internet client 104 and server 101 interact according to the invention.

### DETAILED DESCRIPTION OF THE PREFERRED EMBODIMENTS

The method of the inventions provides risk or opportunity evaluation for the biotechnological and pharmaceutical R&D criteria, preferably presented either digitally or hard-copy in a “Traffic Light Diagram”. This tool utilizes a layout, formatting, and formulas in known spreadsheet programs such as Excel®. The template enables the client/user to easily to interpret color schemes such as of red, yellow and green and the risk and/or opportunity for each criteria.

All steps in the processes described herein are operated in software installed on an apparatus capable of operating such software, including a computer, PDA and the like, preferably a computer, more preferably a computer connected to a network or a server. The software necessary to execute these steps is either known or capable of being designed by those of ordinary skill in the art. Alternatively, certain steps may be performed by a human. Client and server may interact over the World Wide Web in a client-server or business-to-business model. The invention therefore provides a further embodiment featuring an online method for evaluating the risk and/or opportunity for one or more R&D projects, said method comprising the steps of:

providing an online site having a server operable to provide a risk and/or opportunity scale from which one or more clients interact with said server and assess said risk and/or opportunity, said scale providing guidance for scoring a range from low to high;

a client providing to the server scores based on the provided scale of risk and/or opportunity for a plurality of pharmaceutical or biotechnological criteria;

the server calculating risk and/or opportunity data by performing a mathematical weighted-average for each criteria;

optionally calculating further risk and/or opportunity data by performing a mathematical average for each criteria across projects if more than one project is evaluated;

and further optionally converting said data to a color scale for each measured criteria;

the server issuing a response to one or more clients a plurality of data as requested by client by generating a suitable display of said data on a computer terminal or network.

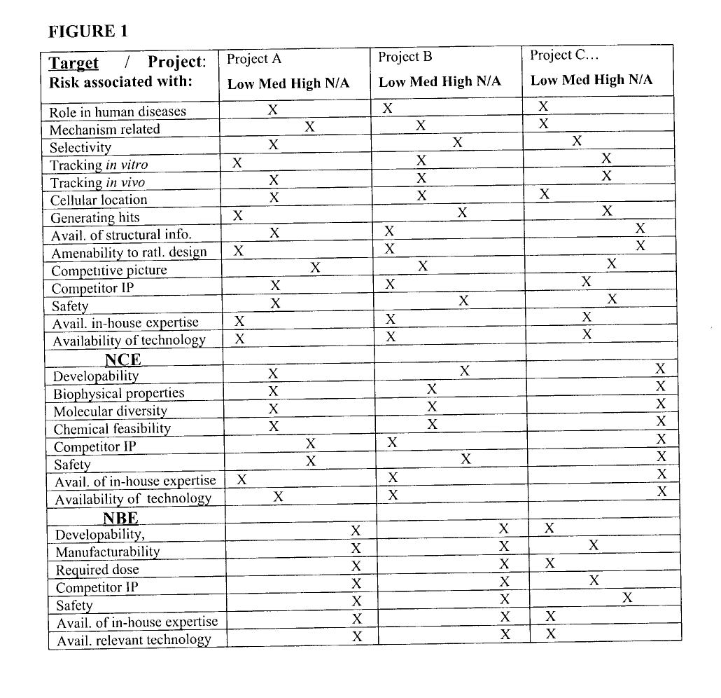

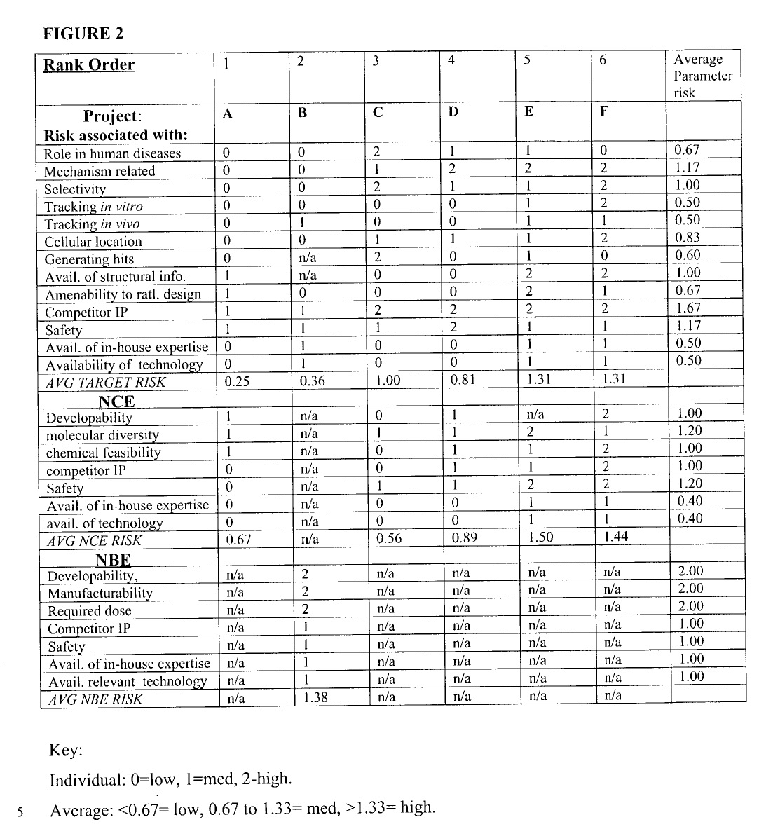

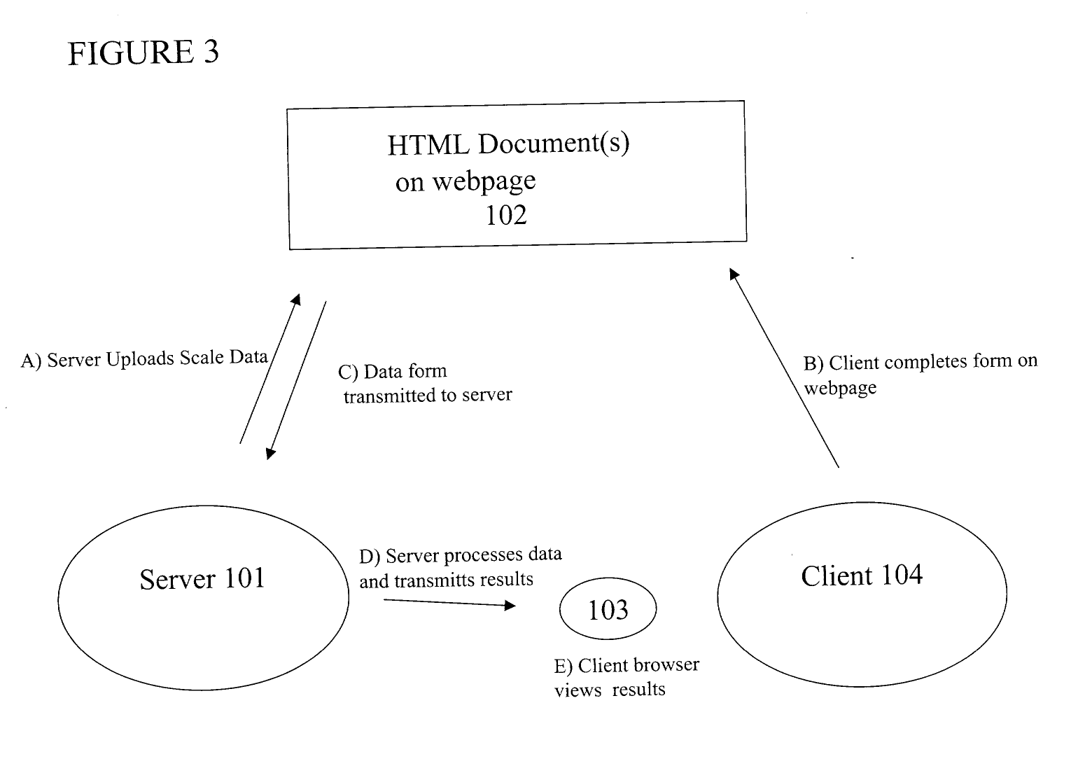

FIG. 3. Depicts the basic steps by which an exchange between an internet client 104 and server 101 interact according to the invention. In this regard, the server 101 places the scale data in HTML or XML on a webpage 102 prompting client 104 to securely enter their information in digital medium on the webpage 102 to be transmitted to the server 101 where a database using, for example, SQL, Excel or MS Access. The database sorts and processes the information in a computer readable HTML page for one or more clients in their browsers 103. Information can be entered securely with programs such as SSL. The initial scale data can be presented by the server 101 on a webpage 102 in an XML or HTML form with blank input spaces for the client 104 to complete the required information. The form can then be transmitted as, for example, a block of data to be processed on the server 101. Server 101 processes the scale data and transmits the processed data in an HTML page to be viewed on browser 103 which resembles FIGS. 1 and 2 suitable to display on a computer terminal.

Biotechnological and pharmaceutical citeria and parameters to be evaluated will be apparent to those skilled in the art. Preferred criteria include, but are not limited to: target, NCE (new chemical entity) or NBE (new biological entity).

Preferred parameters within the target category include: role in human diseases, mechanism related toxicity, selectivity, tracking in vitro, tracking in vivo, cellular location, generating hits, availability of structural information, amenability to rational design, competitive picture, competitor intellectual property, safety, availability of in-house expertise and availability of relevant technology.

Preferred parameters within the NCE category include: developability and biophysical properties, molecular diversity and number of leads, chemical feasibility and rapid lead expansion, competitor intellectual property, safety, availability of in-house expertise and availability of relevant technology.

Preferred parameters within the NBE category include: developability, manufacturability including drug supply to market, required dose, competitor intellectual property, safety, availability of in-house expertise and availability of relevant technology.

What is claimed is:

1. A process of evaluating the risk and/or opportunity for multiple R&D projects, said process comprising:
providing a risk and/or opportunity scale from which one or more clients assess said risk and/or opportunity, said scale providing guidance for scoring a range from low to high;
a client providing scores based on their assessment of risk and/or opportunity for pharmaceutical or biotechnological criteria, said criteria being target, NCE (new chemical entity) or NBE (new biological entity);
obtaining risk and/or opportunity data by performing a mathematical weighted-average for each criteria;
optionally obtaining further risk and/or opportunity data by performing a mathematical average for each criteria across projects if more than one project is evaluated;
and further optionally converting said data to a color scale for each measured criteria presented on hard-copy or digital visual medium;
wherein
the target criteria are chosen from role in human diseases, mechanism related toxicity, selectivity, tracking in vitro, tracking in vivo, cellular location, generating hits, availability of structural information, amenability to rational design, competitive picture, competitor intellectual property, safety, availability of in-house expertise and availability of relevant technology;
the NCE criteria are chosen from developability and biophysical properties, molecular diversity and number of leads, chemical feasibility and rapid lead expansion, competitor intellectual property, safety, availability of in-house expertise and availability of relevant technology; and
the NBE criteria are chosen from: developability, manufacturability including drug supply to market, required dose, competitor intellectual property, safety, availability of in-house expertise and availability of relevant technology.

2. The process according to claim 1 wherein:
wherein
the target criteria are role in human diseases, mechanism related toxicity, selectivity, tracking in vitro, tracking in vivo, cellular location, generating hits, availability of structural information, amenability to rational design, competitive picture, competitor intellectual property, safety, availability of in-house expertise and availability of relevant technology;
the NCE criteria are developability and biophysical properties, molecular diversity and number of leads, chemical feasibility and rapid lead expansion, competitor intellectual property, safety, availability of in-house expertise and availability of relevant technology; and
the NBE criteria are developability, manufacturability including drug supply to market, required dose, competitor intellectual property, safety, availability of in-house expertise and availability of relevant technology.

3. An apparatus capable of evaluating the risk and/or opportunity for one or more R&D projects, said apparatus having a computer program operable to process:
providing a risk and/or opportunity scale to a client from which one or more clients interact with said apparatus and assess said risk and/or opportunity, said scale providing guidance for scoring a range from low to high;
a client providing scores to the apparatus based on the scale of risk and/or opportunity for pharmaceutical or biotechnological criteria, said criteria being target, NCE (new chemical entity) or NBE (new biological entity);
the apparatus calculating risk and/or opportunity data by performing a mathematical weighted-average for each criteria;
optionally calculating further risk and/or opportunity data by performing a mathematical average for each criteria across projects if more than one project is evaluated;
and further optionally converting said data to a color scale for each measured criteria; and
the apparatus subsequently presenting on hard-copy or digital visual medium the results to the clients
wherein
the target criteria are chosen from role in human diseases, mechanism related toxicity, selectivity, tracking in vitro, tracking in vivo, cellular location, generating hits, availability of structural information, amenability to rational design, competitive picture, competitor intellectual property, safety, availability of in-house expertise and availability of relevant technology;
the NCE criteria are chosen from developability and biophysical properties, molecular diversity and number of leads, chemical feasibility and rapid lead expansion, competitor intellectual property, safety, availability of in-house expertise and availability of relevant technology; and
the NBE criteria are chosen from: developability, manufacturability including drug supply to market, required dose, competitor intellectual property, safety, availability of in-house expertise and availability of relevant technology.

4. The apparatus according to claim 3 wherein:
the target criteria are role in human diseases, mechanism related toxicity, selectivity, tracking in vitro, tracking in vivo, cellular location, generating hits, availability of structural information, amenability to rational design, competitive picture, competitor intellectual property, safety, availability of in-house expertise and availability of relevant technology;
the NCE criteria are developability and biophysical properties, molecular diversity and number of leads, chemical feasibility and rapid lead expansion, competitor intellectual property, safety, availability of in-house expertise and availability of relevant technology; and
the NBE criteria are developability, manufacturability including drug supply to market, required dose, competitor intellectual property, safety, availability of in-house expertise and availability of relevant technology.

5. The apparatus according to claims 3 or 4 wherein the apparatus is a computer.

6. An online method for evaluating the risk and/or opportunity for one or more R&D projects, said method comprising the steps of:
providing an online site having a server operable to provide a risk and/or opportunity scale from which one or more clients interact with said server and assess said risk and/or opportunity, said scale providing guidance for scoring a range from low to high;
a client providing to the server scores based on the provided scale of risk and/or opportunity for pharmaceutical or biotechnological criteria, said criteria being target, NCE (new chemical entity) or NBE (new biological entity);
the server calculating risk and/or opportunity data by performing a mathematical weighted-average for each criteria;
optionally calculating further risk and/or opportunity data by performing a mathematical average for each criteria across projects if more than one project is evaluated;
and further optionally converting said data to a color scale for each measured criteria; the server issuing a response to one or more clients a plurality of data as requested by client by generating a suitable display of said data on a computer terminal or network;
wherein
the target criteria are chosen from role in human diseases, mechanism related toxicity, selectivity, tracking in vitro, tracking in vivo, cellular location, generating hits, availability of structural information, amenability to rational design, competitive picture, competitor intellectual property, safety, availability of in-house expertise and availability of relevant technology;
the NCE criteria are chosen from developability and biophysical properties, molecular diversity and number of leads, chemical feasibility and rapid lead expansion, competitor intellectual property, safety, availability of in-house expertise and availability of relevant technology; and
the NBE criteria are chosen from: developability, manufacturability including drug supply to market, required dose, competitor intellectual property, safety, availability of in-house expertise and availability of relevant technology.

7. The online method according to claim 6 wherein:
the target criteria are role in human diseases, mechanism related toxicity, selectivity, tracking in vitro, tracking in vivo, cellular location, generating hits, availability of structural information, amenability to rational design, competitive picture, competitor intellectual property, safety, availability of in-house expertise and availability of relevant technology;
the NCE criteria are developability and biophysical properties, molecular diversity and number of leads, chemical feasibility and rapid lead expansion, competitor intellectual property, safety, availability of in-house expertise and availability of relevant technology; and
the NBE criteria are developability, manufacturability including drug supply to market, required dose, competitor intellectual property, safety, availability of in-house expertise and availability of relevant technology.
